(19) United States
(12) Patent Application Publication
(10) Pub. No.: US 2021/0079941 A1
(43) Pub. Date: Mar. 18, 2021

(54) PUSHED-IN LOCKING/ANCHORING SYSTEM FOR CONNECTING ADJACENT STRUCTURE FORMING MEMBERS

(71) Applicant: Home Plus Group, Inc., Fountain Valley, CA (US)

(72) Inventors: Tin Huu Phan, Westminster, CA (US); Khoa Phan, Garden Grove, CA (US)

(21) Appl. No.: 16/568,413

(22) Filed: Sep. 12, 2019

(51) Int. Cl. F16B 13/06

(52) U.S. Cl. CPC F16B 13/063

(57) ABSTRACT

A pushed-in place locking system that connects adjacent structure forming members including a locking housing and an internal core operably associated therewith. The locking housing has a first segment and a second segment. The first segment has a first expanding section, a second expanding section and an elongated slot disposed therebetween. The elongated slot extends through the first segment. The first segment has a breakable connecting member connecting adjacent terminal ends of the first and second expanding sections. The locking system is configured such that the internal core is initially inserted into the second segment and subsequently into the first segment, wherein the breakable connecting member breaks as the internal core extends into the first segment a predetermined distance and the first expanding section and the second expanding section expand outwardly to anchor the first segment in the internal bore formed in a first structure forming member.

### FIELD OF THE INVENTION

A preferred form of the present invention is directed to an anchor or locking system that is pushed into place to lock or otherwise connect adjacent structure forming members. In a preferred form, the anchor or locking system includes a metal core that can take the form of a cylindrical rod and an outer locking/anchoring shell or housing having a first set of outwardly projecting teeth, serrations, ridges, etc. to lock or otherwise connect a first portion of the locking system to a first structure forming member and a second set of outwardly projecting teeth, serrations, ridges, etc. to lock or otherwise connect a second portion of the locking system to a second structure forming member to firmly connect the first structure forming member to the second structure forming member. Preferably, the outer locking shell is formed from a non-metallic material (e.g., plastic) and is configured to receive the metal core. The locking system is preferably completely hidden when installed in an operating position. The metal core is preferably configured to reinforce and strengthen the connection of adjacent structure forming members. In a most preferred form, the locking system consists only two pieces, i.e., the non-metallic outer locking shell or housing and the metallic core.

### BACKGROUND OF THE INVENTION

A wide variety of anchoring systems have been developed to connect adjacent structure forming members that form portions of various commonly used structures or objects including but not limited to cabinets, vanities, drawers, desks, dressers and bookshelves. One popular anchoring system for connecting components of a storage device or other structural component includes a male member positioned in one structure forming member and a female member positioned in the adjoining structure forming member. At least a portion of this type of anchoring system is visible. Further, these types of anchoring systems are complex, expensive to manufacture and not easily installed.

Accordingly, a significant need exits for anchoring systems that can be easily and readily installed even by an unskilled laborer, have a prolonged life, are easily, readily and inexpensively manufactured, invisible once installed and reliably and securely and strongly connect adjoining structure forming members. In particular, there is a need for an anchoring system that only requires simple drilling to form a single internal bore in each of the adjoining structure forming members and pushing of the anchoring system into the drilled bores to reliably and securely connect portions of the adjoining structure forming members.

### OBJECTS AND SUMMARY OF THE INVENTION

An object of the present invention is to provide a novel and unobvious anchoring or locking system for locking or otherwise connecting adjacent structure forming members.

Another object of a preferred embodiment of the present invention is to provide an anchoring or locking system for locking or otherwise connecting adjacent structure forming members that can be readily and easily installed by an unskilled laborer.

A further object of a preferred embodiment of the present invention is to provide an anchoring or locking system for locking or otherwise connecting adjacent structure forming members that can be easily and inexpensively manufactured.

Yet another object of a preferred embodiment of the present invention is to provide an anchoring or locking system that does not require installation of separate components (e.g., male and female parts) that need to be installed separately into different structure forming members and subsequently connected.

Still a further object of a preferred embodiment of the present invention is to provide a locking or anchoring system that only requires simple drilling and pushing of the components of locking or anchoring system to securely connect adjacent structure forming members.

Still yet a further object of a preferred embodiment of the present invention is to provide a locking or anchoring system that consists of only two pieces, portions of each of which are pushed into drilled bores of adjacent structure forming members to securely connect the adjacent structure forming members.

Yet a further object of a preferred embodiment of the present invention is to provide a locking or anchoring system that includes a locking housing or shell having at least two expansion members that are initially connected to each other to facilitate insertion in a drilled bore of a structure forming member and during installation of an internal core of the locking system the connection is broken to allow the two expansion members to expand outwardly and lock in the drilled bore of the structure forming member.

A further object of a preferred embodiment of the present invention is to provide a space saving locking or anchoring system that facilitates joining thin and small boards or panels together.

Still a further object of a preferred embodiment of the present invention is to provide a locking or anchoring system having a single piece housing with locking mechanisms (e.g., a plurality of plastic teeth) utilizing the holding property of wood, particle board, MDF boards, etc. to connect adjacent structure forming members and a metal internal core which can be easily and readily installed to reinforce and strengthen the connection of the adjacent structure forming members.

It must be understood that no one embodiment of the present invention need include all the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to a locking system that is pushed into place to lock or otherwise connect adjacent structure forming members. The locking system includes a locking housing forming an outermost portion of the locking system. The locking housing includes a first section and a second section. The first section is configured to be inserted in an internal bore formed in a first structure forming member and the second section is configured to be inserted in an internal bore formed in a second structure forming member. The first section has a length greater than the second section. The first section has a first sleeve, a second sleeve, a first elongated opening formed in an exterior of the first section, a second elongated opening formed in an exterior of the first section opposite the first elongated opening and an elongated slot extending through the first section and connecting the first elongated opening and the second elongated opening. The first and second sleeves each have a plurality of anchoring members for locking or otherwise connecting the first section to the first structure forming member. The second section is annular and has an internal bore. The second section has a plurality of anchoring members for locking or otherwise connecting the second section to the second structure forming member. An internal core is operably associated with the locking housing. The internal core is configured to be inserted into and disposed in the internal bore of the second section and an interior of the first section to reinforce and strengthen the locking system.

Another preferred embodiment of the present invention is directed to a method of connecting a first structure forming member to a second structure forming member. The method includes the steps of: (a) providing a first structure forming member with a first internal bore; (b) providing a second structure forming member with a second internal bore; (c) providing a locking system for connecting the first structure forming member to the second structure forming member, the locking system includes a locking housing and an internal core, the locking housing has a first section and a second section, the first section has a first sleeve, a second sleeve, a first elongated opening formed in an exterior of the first section, a second elongated opening formed in an exterior of the first section opposite the first elongated opening and an elongated slot extending through the first section and connecting the first elongated opening to the second elongated opening, the first and second sleeves each include a plurality of anchoring members for locking or otherwise connecting the first section to the first structure forming member, the second section is annular and has an internal bore, the second section has a plurality of anchoring members for locking or otherwise connecting the second section to the second structure forming member; (d) inserting the first section of the locking member in the first internal bore formed in the first structure forming member; (e) inserting the internal core into the first section and the second section of the locking member; and, (f) inserting the second section of the locking member into the second internal bore formed in the second structure forming member.

A further preferred embodiment of the present invention is directed to a locking system that is pushed into place to lock or otherwise connect adjacent structure forming members. The locking system includes a locking housing and an internal core operably associated with the locking housing to connect adjacent structure forming members together. The locking housing has a first segment and a second segment. The first segment is configured to be inserted in an internal bore formed in a first structure forming member and the second segment is configured to be inserted in an internal bore formed in a second structure forming member. The first segment includes a first expanding section, a second expanding section and an elongated slot disposed between the first expanding section and the second expanding section. The elongated slot extends through the first segment. The first segment further includes a breakable connecting member connecting a terminal end of the first expanding section to a terminal end of the second expanding section. The first segment has at least one anchoring member for locking or otherwise connecting the first segment to the first structure forming member. The second segment has at least one anchoring member for locking or otherwise connecting the second segment to the second structure forming member. An internal core is operably associated with the locking housing. The locking system is configured such that the internal core is initially inserted into the second segment and subsequently into the first segment, wherein the breakable connecting member breaks as the internal core extends into the first segment a predetermined distance and the first expanding section and the second expanding section expand outwardly to anchor the first segment in the internal bore formed in the first structure forming member.

The preferred forms of the present invention described above provide various examples of preferred embodiments of the present invention and are not to be construed as limiting the present invention to any of the preferred forms described above.

### BRIEF DESCRIPTION OF THE DRAWINGS

FIG. 1 is a schematic view of a preferred locking system connecting to structure forming members that are oriented perpendicularly.

FIG. 2 is a perspective view of a locking system formed in accordance with a preferred embodiment of the present invention.

FIG. 3 is a perspective view of a locking system formed in accordance with a preferred embodiment of the present invention with the internal, metallic core partially inserted in the non-metallic locking housing.

FIG. 4 is a perspective view of the embodiment illustrated in FIG. 3 taken from a different vantage point.

FIG. 5 is an elevational view of the locking system formed in accordance with the preferred embodiment of the present invention.

FIG. 6 is an elevational view similar to FIG. 5 with the locking housing rotated 90 degrees.

FIG. 7 is a bottom view of the preferred locking system.

FIG. 8 is a top view of the preferred locking system.

FIG. 9 is a perspective view of the preferred locking system with the internal core fully inserted in the locking housing.

### DETAILED DESCRIPTION OF THE PREFERRED EMBODIMENTS OF THE INVENTION

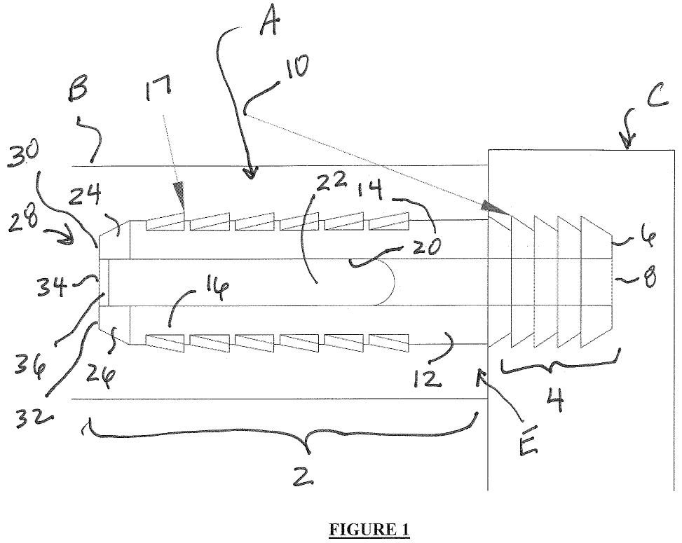

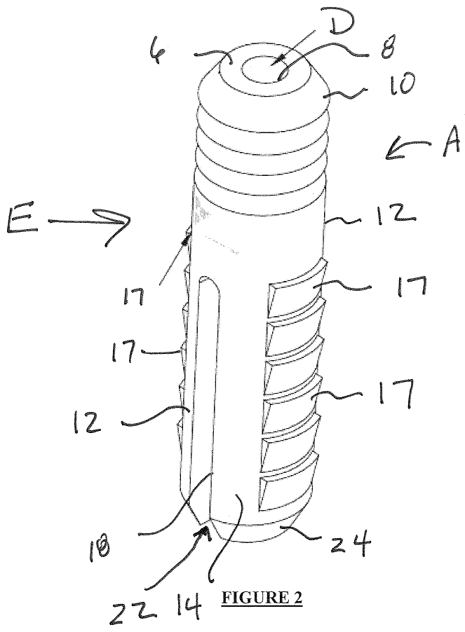

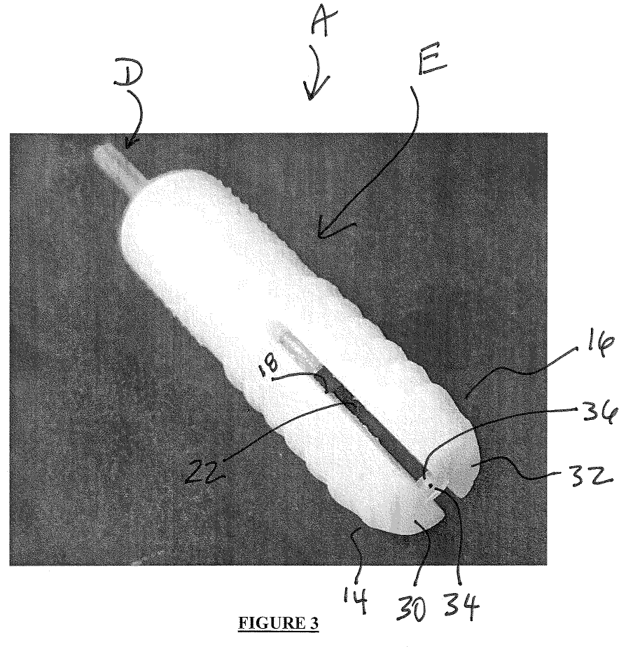

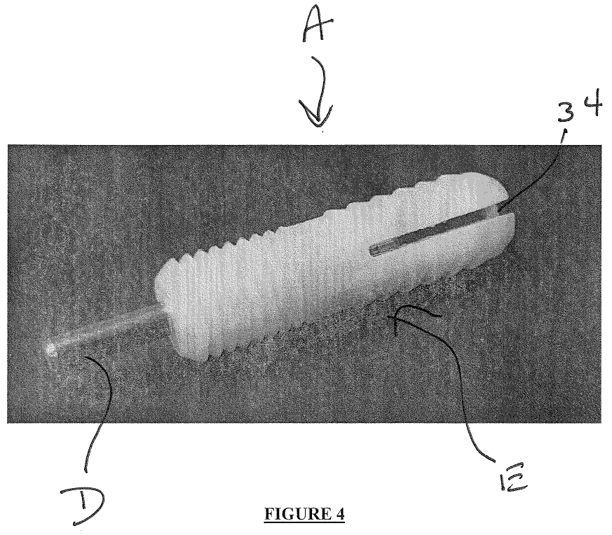

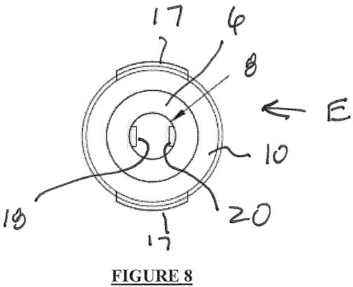

The preferred forms of the invention will now be described with reference to FIGS. 1-9. The appended claims are not limited to the preferred form and no term and/or phrase used herein is to be given a meaning other than its ordinary meaning unless it is expressly stated otherwise.

### FIGS. 1 Through 9

Referring to FIGS. 1 to 9, an anchoring or locking system A employing a preferred form of the invention is illustrated in one of many possible configurations. In the most preferred form, the anchoring or locking system A securely connects a first structure forming member B to a second structure forming member C. Preferably, the first structure forming member B is oriented perpendicular to the second structure forming member C. The first and second structure forming members can form portions of any useable structures including but not limited to cabinets, vanities, drawers, desks, dressers and bookshelves. The first and second structure forming members can be formed from any suitable material or materials. For example, the structure forming members can be wood panels or boards, particle boards or MDF (medium-density fibreboard) boards.

In a most preferred form, the locking system A includes only two pieces, i.e., an internal core D and an outer shell or housing E opposing portions of core D and housing E extend into the first and second structure forming members B and C. In a most preferred form, internal core D is formed from metal and the outer shell or housing E is formed from a non-metallic material (e.g., plastic). However, it is to be noted that the components of locking system A can be formed from any suitable material. In a most preferred form, when the locking system A is installed in an operating or final position, no portion of the locking system A is visible as the first and second structure forming members directly abut/contact each other and the corresponding portions of the locking system A are completely embedded in the first structure forming member and the second structure forming member.

The locking shell or housing E preferably includes a first section or segment 2 configured to be inserted into a single drilled opening in the first structure forming member B and a second section or segment 4 configured to be inserted into a single drilled opening in the second structure forming member C. Preferably, the first section 2 has a length greater than the length of the second section 4. Second section 4 includes an upper surface 6 having an internal bore or opening 8 for receiving the internal core D. Second section 4 further includes a locking mechanism which preferably includes a plurality of annular locking teeth 10. Preferably, the locking teeth 10 are conically shaped. However, any suitably configured locking mechanism can be used to anchor or lock the second section 4 in the internally drilled bore in the second structure forming member C.

First section 2 preferably includes an annular section 12 directly below a lower end of second section 4. First section 2 also preferably includes a first expanding sleeve, finger or shell portion 14, a second expanding sleeve, finger or shell portion 16, an first elongated opening 18, a second elongated opening 20 and an elongated slot 22 extending through the first section 14 and connecting the first elongated opening 18 to the second elongated opening 20. Preferably, the first elongated opening 18 is positioned directly opposite the second elongated opening 20. Further, the first elongated opening 18 preferably has an identical shape and size to the second elongated opening 20.

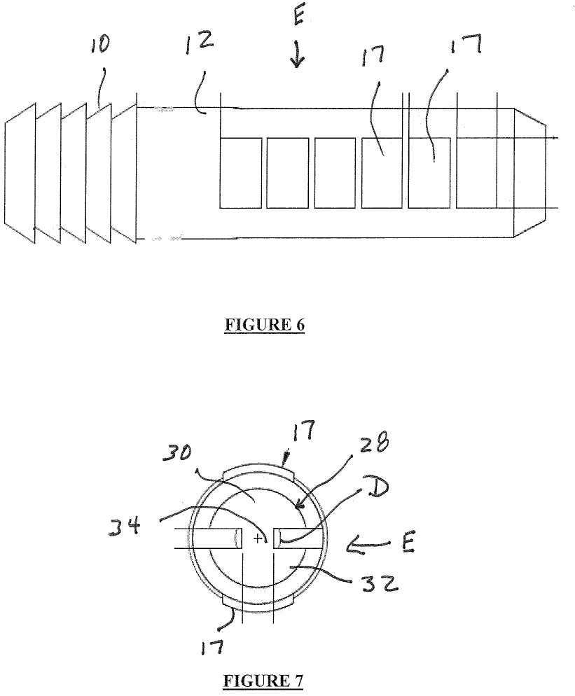

A lower end 24 of portion 14 and lower end 26 of portion 16 are preferably tapered inwardly to facilitate insertion of section 2 into the drilled bore formed in member B. Portions 14 and 16 each preferably include a plurality of vertically aligned teeth 17. The teeth 17 are preferably identical in shape and size. Each of the teeth 17 are tapered inwardly and have an arcuate outer surface. Teeth 17 are configured to engage and lock section 2 to the corresponding inner surface of the bore formed in member B. Each tooth 17 preferably has a circumferential length less than the circumferential length of the corresponding expanding portion as is readily evident from FIG. 6 showing the sides of each tooth 17 spaced inwardly from the corresponding side of the expanding portion or sleeve.

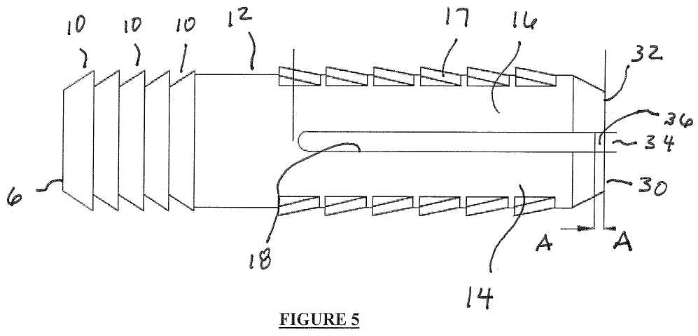

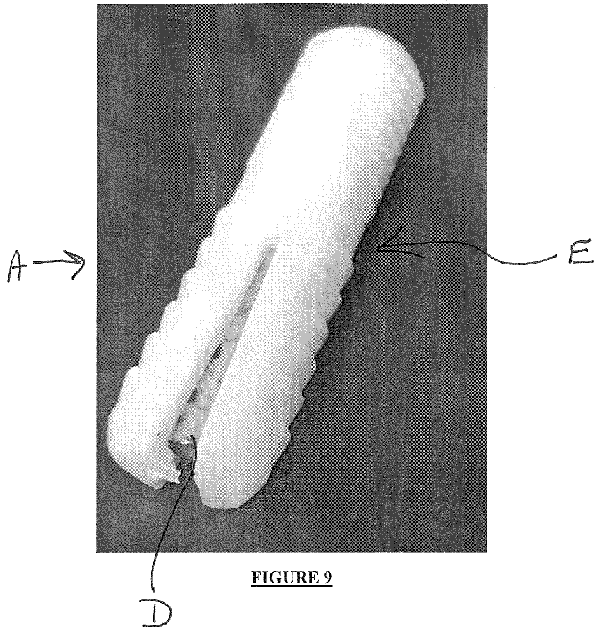

Referring to FIGS. 1, 3 and 7, first section 2 includes a bottom surface 28 formed by bottom surface section 30 of portion 14, bottom surface section 32 of portion 16 and bottom surface section 34 of connecting member 36. Bottom surface sections 30, 32 and 34 preferably extend in a common horizontal plane, i.e., surface sections 30, 32 and 34 are horizontally aligned. Connecting section or portion 36 holds the lower ends of portion 14 and portion 16 together to facilitate the insertion of the first section 2 into the drilled bore formed in member B. Connecting section 36 has a reduced size to allow the connection of the lower end of portion 14 to the lower end of portion 16 to break (as shown in FIG. 9) once the core D has been inserted into the first section 2 a predetermined distance allowing portions 14 and 16 to expand outwardly to lock first section 2 in member B. The reduced height of section 36 is shown by arrows A-A in FIG. 5. The reduced width of section 36 is shown in FIG. 7. Bottom surface portion 34 of section 36 connects bottom surface portion 30 to bottom surface portion 32.

A preferred method of securely connecting structure forming members B and C together using locking system A will now be described. At some point prior to insertion of first section 2 into member B, a single internal bore is formed in member B by a simple and brief drilling process. The internal bore is sized to allow complete insertion of section 2 into the internal bore formed in member B. Section 2 is pushed into the internal bore formed in member B such that the entire length of the second section 4 remains exposed. Subsequently, the internal core D is inserted into opening 8 of section 4 and pushed into an operating position wherein in an upper portion of core D is horizontally aligned or substantially horizontally aligned with surface 6 of second section 4. This insertion processes causes the lower connection of portions 14 and 16 to break as shown in FIG. 9 and outer portions of core D engage planar or other suitably shaped inner surfaces of portions 14 and 16 forcing portions 14 and 16 to expand outwardly to anchor or lock first section 2 in member B.

At some point prior to insertion of second section 4 into member C, a single internal bore is formed in member C by a simple and brief drilling process. The internal bore is sized to allow complete insertion of section 4 into the internal bore formed in member C. Member C is perpendicularly oriented to member B with the bore formed in member C horizontally aligned with the second section 4 housing a portion of core D. Subsequently, second section 4 is pushed into the bore formed in member C so that adjacent surfaces of members B and C are directly abutting and flush. The above process makes it very easy to readily and securely connect adjacent structure forming members so that no portion of the locking system A is visible.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. A locking system that is pushed into place to lock or otherwise connect adjacent structure forming members, said locking system comprising:
(a) a locking housing forming an outermost portion of said locking system, said locking housing having a first section and a second section, said first section being configured to be inserted in an internal bore formed in a first structure forming member and said second section being configured to be inserted in an internal bore formed in a second structure forming member, said first section having a length greater than said second section, said first section having a first sleeve, a second sleeve, a first elongated opening formed in an exterior of said first section, a second elongated opening formed in an exterior of said first section opposite said first elongated opening and an elongated slot extending through said first section and connecting said first elongated opening and said second elongated opening, said first and second sleeves each having a plurality of anchoring members for locking or otherwise connecting said first section to the first structure forming member, said second section being annular and having an internal bore, said second section having a plurality of anchoring members for locking or otherwise connecting said second section to the second structure forming member; and,
(b) an internal core operably associated with said locking housing, said internal core being configured to be inserted into and disposed in said internal bore of said second section and an interior of said first section to reinforce and strengthen said locking system.

2. The locking system as recited in claim 1, wherein:
(a) said locking housing is formed from a non-metallic material and said internal core is formed from a metallic material.

3. The locking system as recited in claim 2, wherein:
(a) each of said plurality of anchoring members of said second section is an annular tooth.

4. The locking system as recited in claim 3, wherein:
(a) said internal core has a substantially constant diameter over a length of said internal core.

5. The locking system as recited in claim 4, wherein:
(a) said first structure forming member is oriented perpendicular to said second structure forming member.

6. The locking system as recited in claim 1, wherein:
(a) said locking housing includes a connecting member connecting a terminal end portion of said first sleeve to a terminal end portion of said second sleeve wherein said connecting member forms a portion of a first end surface of said locking housing.

7. The locking system as recited in claim 6, wherein:
(a) said locking housing is formed from a single piece of material.

8. A method of connecting a first structure forming member to a second structure forming member, said method comprising the steps of:
(a) providing a first structure forming member with a first internal bore;
(b) providing a second structure forming member with a second internal bore;
(c) providing a locking system for connecting the first structure forming member to the second structure forming member, said locking system including a locking housing and an internal core, said locking housing having a first section and a second section, said first section having a first sleeve, a second sleeve, a first elongated opening formed in an exterior of said first section, a second elongated opening formed in an exterior of said first section opposite said first elongated opening and an elongated slot extending through said first section and connecting said first elongated opening to said second elongated opening, said first and second sleeves each having a plurality of anchoring members for locking or otherwise connecting said first section to the first structure forming member, said second section being annular and having an internal bore, said second section having a plurality of anchoring members for locking or otherwise connecting said second section to the second structure forming member;
(d) inserting said first section of said locking member in the first internal bore formed in the first structure forming member;
(e) inserting said internal core into said first section and said second section of said locking member; and,
(f) inserting said second section of said locking member into the second internal bore formed in the second structure forming member.

9. The method as recited in claim 8, wherein:
(a) said locking housing includes a connecting member connecting a terminal end portion of said first sleeve to a terminal end portion of said second sleeve wherein said connecting member forms a portion of a first terminal end surface of said locking housing.

10. The method as recited in claim 9, wherein:
(a) during step (e) of claim 8, said connecting member is broken during insertion of the internal core into the first section of the locking housing.

11. The method as recited in claim 9, further including the step of:
(a) forming said first section, said second section and said connecting member from a single piece of non-metallic material.

12. The method as recited in claim 11, further including the step of:
(a) forming said internal core from a metallic material.

13. The method as recited in claim 8, further including the step of:
(a) orienting said first structure forming member perpendicular to said second structure forming member.

14. The method as recited in claim 13, further including the step of:
(a) forming said first internal bore to have a length greater than a length of said second internal bore.

15. The method as recited in claim 14, wherein:
(a) each of said plurality of anchoring members of said second section is an annular tooth.

16. A locking system that is pushed into place to lock or otherwise connect adjacent structure forming members, said locking system comprising:
(a) a locking housing and an internal core operably associated with the locking housing to connect adjacent structure forming members together;
(b) said locking housing having a first segment and a second segment, said first segment being configured to be inserted in an internal bore formed in a first structure forming member and said second segment being configured to be inserted in an internal bore formed in a second structure forming member, said first segment having a first expanding section, a second expanding section and an elongated slot being disposed between said first expanding section and said second expanding section, said elongated slot extending through said first segment, said first segment further including a breakable connecting member connecting a terminal end of said first expanding section to a terminal end of said second expanding section, said first segment having at least one anchoring member for locking or otherwise connecting said first segment to the first structure forming member, said second segment having at least one anchoring member for locking or otherwise connecting said second segment to the second structure forming member; and,
(b) an internal core operably associated with said locking housing, said locking system being configured such that said internal core is initially inserted into said second segment and subsequently into said first segment, wherein said breakable connecting member breaks as said internal core extends into said first segment a predetermined distance and said first expanding section and said second expanding section expand outwardly to anchor said first segment in the internal bore formed in the first structure forming member.

17. The locking system as recited in claim 16, wherein:
(a) no portion of said locking housing and no portion of said internal core are visible once the first structure forming member is connected flush with the second structure forming member.

18. The locking system as recited in claim 17, wherein:
(a) said locking housing is formed from a single piece of non-metallic material and said internal core is formed from a metallic material.

19. The locking system as recited in claim 18, wherein:
(a) said second segment includes a plurality of longitudinally aligned annular teeth.

20. The locking system as recited in claim 19, wherein:
(a) said first expanding section and said second expanding section each include a plurality of longitudinally aligned teeth that have a circumferential length less than a circumferential length of the corresponding expanding section.
